(19) United States
(12) Patent Application Publication
(10) Pub. No.: US 2021/0297652 A1
(43) Pub. Date: Sep. 23, 2021

(54) Three-Dimensional Electronic Aquarium

(71) Applicants: Rick Gibson, Las Vegas, NV (US); Vic Gibson, Las Vegas, NV (US)

(72) Inventors: Rick Gibson, Las Vegas, NV (US); Vic Gibson, Las Vegas, NV (US)

(21) Appl. No.: 17/209,399

(22) Filed: Mar. 23, 2021

Related U.S. Application Data
(60) Provisional application No. 62/993,416, filed on Mar. 23, 2020.

(51) Int. Cl. H04N 13/302; A47B 81/06; G02B 30/56; H04N 5/64; A47G 1/02

(52) U.S. Cl. CPC H04N 13/302; A47B 81/06; A47G 1/02; H04N 5/64; G02B 30/56

(57) ABSTRACT

A three dimensional electronic aquarium is shown and described. The three dimensional electronic aquarium includes an aquarium tank comprised of a base having a front wall rising therefrom. The front wall is transparent. A three dimensional television secured in a back portion of the aquarium tank opposite the front wall. The three dimensional television will display at least one fish. A mirror positioned along a bottom portion of the three dimensional television.

### CROSS REFERENCE TO RELATED APPLICATIONS

This application claims the benefit of U.S. Provisional Application No. 62/993,416 filed on Mar. 23, 2020. The above identified patent application is herein incorporated by reference in its entirety to provide continuity of disclosure.

### BACKGROUND OF THE INVENTION

The present invention relates to fish aquarium. More particularly, the present invention provides an aquarium that uses a three dimensional projection instead of live fish and water.

Many individuals enjoy having an aquarium in their home or business. Traditional aquariums require a significant amount of effort to properly take care of an maintain. The fish will need regularly fed, the water will need constantly cleaned or changed, temperatures must be kept proper. If even on of these things is overlooked or not completed properly the fish may die. This could result in an expensive and sad event of having to start over from scratch.

Further, traditional aquariums have a large amount of potential for accidents to happen. This can cause large amounts of damage not only to the aquarium but to the surrounding area. In some instances, the tank may break leaking water. Other times, the filtration system may break leaving an awful odor. In severe instances these breaks may cause the fish to die.

Consequently, there is a need for an improvement in the art of aquariums. The present invention substantially diverges in design elements from the known art while at the same time solves a problem many people face when having an aquarium but not wanting to have to maintain live fish. In this regard the present invention substantially fulfills these needs.

### SUMMARY OF THE INVENTION

The present invention provides a three dimensional electronic aquarium wherein the same can be utilized for providing convenience for the user when having an aquarium. The three dimensional electronic aquarium is comprised of an aquarium tank comprised of a base having a front wall rising therefrom. The front wall is transparent. A three dimensional television secured in a back portion of the aquarium tank opposite the front wall. The three dimensional television will display at least one fish. A mirror positioned along a bottom portion of the three dimensional television.

Another object of the three dimensional electronic aquarium is to have an aquarium tank cabinet. The aquarium tank cabinet has a base with a plurality of sidewalls rising therefrom, an upper surface is secured to the top of the plurality of sidewalls. The upper surface will support the aquarium tank.

Another object of the three dimensional electronic aquarium is to have a media player electrically coupled to the three dimensional television.

Another object of the three dimensional electronic aquarium is to have a top section placed along a top portion of the three dimensional television.

Another object of the three dimensional electronic aquarium is to have a top section which extends away from the three dimensional television toward the front wall.

Another object of the three dimensional electronic aquarium is to have a top section which is black.

Another object of the three dimensional electronic aquarium is to have a which mirror extends away from the three dimensional television toward the front wall.

Another object of the three dimensional electronic aquarium is to have a mirror is positioned such that it is angled with respect to a plane perpendicular to the three dimensional television.

Another object of the three dimensional electronic aquarium is to have the aquarium tank cabinet is further include of an opening in a front sidewall. The opening will have a door is secured over the opening.

Another object of the three dimensional electronic aquarium is to have the aquarium tank cabinet have at least one side section rising adjacent to the aquarium tank from the upper surface.

Another object of the three dimensional electronic aquarium is to have aquarium tank cabinet have a top section secured to a top of the at least one side section, such that the top section sits along a top of the aquarium tank.

Other objects, features and advantages of the present invention will become apparent from the following detailed description taken in conjunction with the accompanying drawings.

### BRIEF DESCRIPTION OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows a cross-sectional view of an embodiment of the three dimensional electronic aquarium.

FIG. 2 shows a front view of an embodiment of the three dimensional electronic aquarium.

FIG. 3 shows a top down view of an embodiment of the three dimensional electronic aquarium.

FIG. 4 shows a perspective view of an embodiment of the three dimensional electronic aquarium in a cabinmate.

FIG. 5 shows a wiring diagram of an embodiment of the three dimensional electronic aquarium.

### DETAILED DESCRIPTION OF THE INVENTION

Reference is made herein to the attached drawings. Like reference numerals are used throughout the drawings to depict like or similar elements of the three dimensional electronic aquarium. For the purposes of presenting a brief and clear description of the present invention, a preferred embodiment will be discussed as used for the three dimensional electronic aquarium. The figures are intended for representative purposes only and should not be considered to be limiting in any respect.

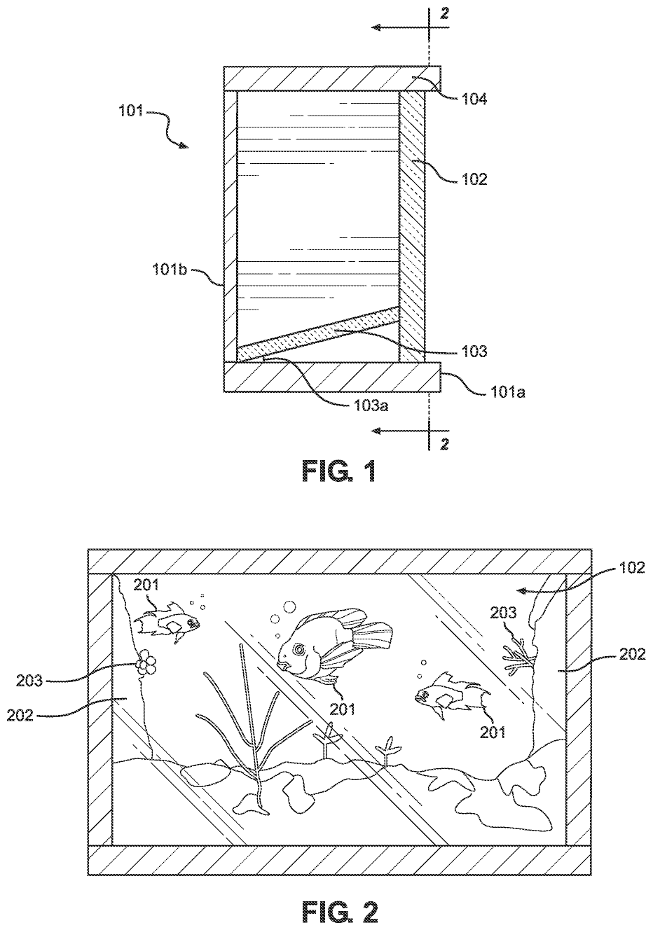

Referring now to FIG. 1, there is shown a cross-sectional view of an embodiment of the three dimensional electronic aquarium. The three dimensional electronic aquarium is comprised of an aquarium tank 101. The aquarium tank has a base 101a. The aquarium tank 101 further includes a front wall 101b. The front wall 101b will rise from the base 101a. In some embodiments, the aquarium tank 101 includes at least one sidewall. The sidewalls will rise from the base 101a and will attached to the edges of the front wall 101b. In other embodiments the aquarium tank 101 includes a rear wall. The three dimensional electronic aquarium does not require a fully enclosed aquarium tank, as no water is required for this aquarium.

The three dimensional electric aquarium further includes a three dimensional screen 102. The three dimensional screen 102 will show three dimensional images. In one embodiment the three dimensional screen 102 is a television. In one embodiment the three dimensional screen does not require any special eye wear for the three dimensional picture to appear. In one embodiment the three dimensional screen 102 is positioned such that it rises from the base 101a opposite the front wall 101b. This will allow for the aquarium tank 101 to at a minimum appear to fully enclose the three dimensional screen 102.

The three dimensional electronic aquarium further includes a mirror 103. In one embodiment the mirror 103 is located along the bottom of the three dimension screen 102. In one embodiment the mirror 103 extends outward away from the three dimensional screen 102. In one embodiment the mirror is angled such that it forms an angle of between 0 and 30 degrees where the apex 103a is formed by the mirror 103 and the base 101a. The mirror will prevent an individual from seeing the bottom of the aquarium tank 101 and any outline of the three dimensional screen 102.

In some embodiments the three dimensional aquarium includes a top section 104. The top section 104 will extend from a top section of the three dimensional screen toward the front wall 101b. In one embodiment the top section 104 is black. In another embodiment the top section 104 is angled. In one embodiment the top section 104 is configured to look like a traditional aquarium lid.

Referring now to FIG. 2, there is shown a front view of an embodiment of the three dimensional electronic aquarium. From the front of the three dimensional electronic aquarium the aquarium will look exactly like a traditional aquarium. The three dimensional screen 102 will display at least one fish 201. The at least one fish will be able to move around and exhibit typical fish behavior. The mirror 103 will prevent the observer from seeing the lower section of the three dimensional screen 102.

In different embodiment the sides of the three dimensional screen 102 will be hidden by various aspects. In the shown embodiment the sides of the three dimensional screen are hidden using underwater structures 202. These underwater structures 202 stretch along the edges of the three dimensional electronic aquarium. There underwater structures 202 also add decoration to the aquarium. In the shown view coral and plants 203 are built into the underwater structures 202.

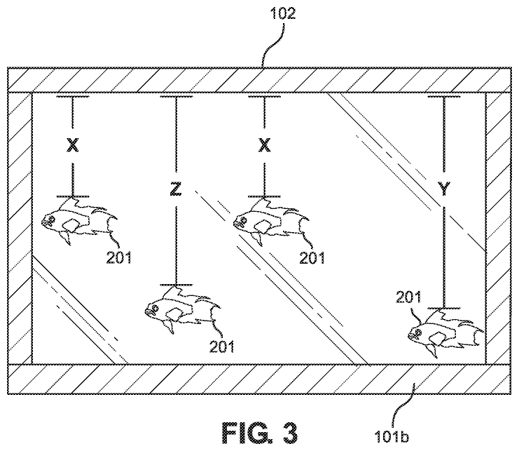

Referring now to FIG. 3, there is shown a top down view of an embodiment of the three dimensional electronic aquarium. In many embodiments three dimensional screen 102 is capable of projecting fish 201 and underwater items at different depths from the front wall 101b. In the shown embodiment there are fish at three different dimensions of fish 201. The fish 201 are displayed at distances x, y, and z from the three dimensional screen 102. This will allow for a more lifelike appearance. Other distances and combinations of distances may be used to achieve this effect and this example is in no way meant to be limiting.

In other embodiments other things may be displayed instead of simple fish 201. In one embodiment the aquarium shows various aquatic animals as desired by the owner. In other embodiments the aquarium may display other marine centered themes. For example, a mermaid may be displayed.

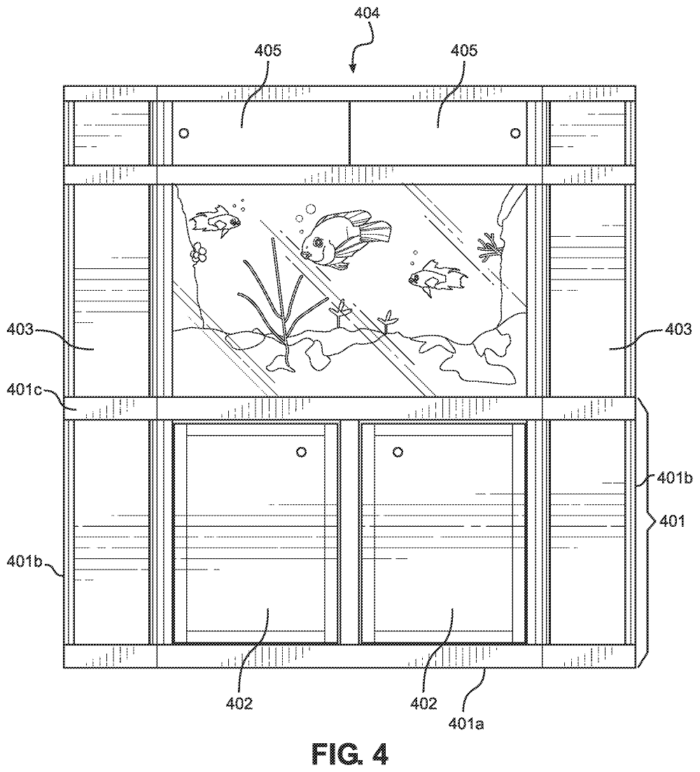

Referring now to FIG. 4, there is shown a perspective view of an embodiment of the three dimensional electronic aquarium in a cabinet. In different embodiments the three dimensional electronic aquarium is built on or into a cabinet. The cabinet may have varying features and structural elements. In the shown embodiment the aquarium tank cabinet includes a base section 401. The base section 401 includes a base 401a and a plurality of sidewalls 401b rising from the base 401a. Atop the plurality of sidewalls 401b there is an upper surface 401c. The upper surface 401c will support the aquarium tank. In the shown embodiment the base section 401 further has two cabinet doors 402 therein. The cabinet doors 402 will open to an interior volume which is capable of housing items.

Further, the shown embodiment of an aquarium tank cabinet includes a pair of side sections 403. The pair of side sections 403 are secured to the upper surface 401c of the base section 401. The pair of side sections 403 will rise along the sides of the aquarium tank. In some embodiments the pair of side sections 403 will be used to hide the sides of the three dimensional screen. In other embodiments the side sections 403 include items such as shelves.

In the shown embodiment the aquarium cabinet includes a top section 404. The top section 404 is secured to the side sections 403. In one embodiment the top section 404 sits along the top of the aquarium tank. In one embodiment the cabinet will fully enclose the perimeter of the aquarium tank. In the shown embodiment the top section 404 includes storage locations. In the shown embodiment these storage locations are closed with sliding doors 405.

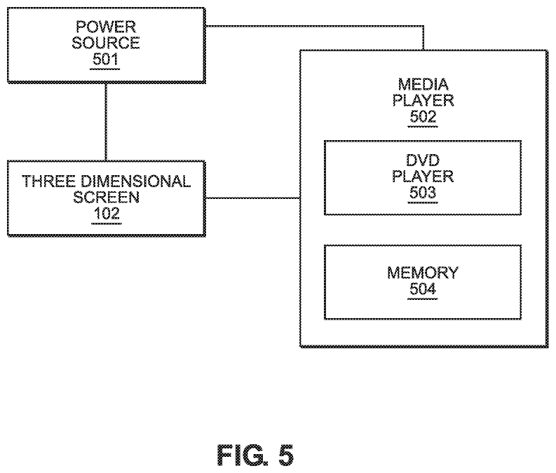

Referring now to FIG. 5, there is shown a wiring diagram of an embodiment of the three dimensional electronic aquarium. The three dimensional electronic aquarium includes a power source 501. The power source 501 may be any manner of supplying the necessary amount of power required by the aquarium. The power source 501 is electrically coupled to a three dimensional screen 102. The three dimensional screen 102 is further electrically coupled to a media player 502.

In one embodiment the media player 502 includes a DVD player 503. The DVD player 503 will allow DVDs to be played via the three dimensional screen 102. In another embodiment the media player 502 includes a memory 504. The memory 504 is capable of storing videos to be displayed via the three dimensional screen 102. In these ways the owner of the three dimensional electronic aquarium is not limited to any one set of displayed fish or activities.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

We claim:

1) A three dimensional electronic aquarium, the aquarium comprising:
An aquarium tank comprised of a base and at least a front wall rising therefrom;
A three dimensional television secured in a back portion of the aquarium tank opposite the front wall, wherein the three dimensional television will display at least one fish;
A mirror positioned along a bottom portion of the three dimensional television.

2) The three dimensional electronic aquarium of claim 1, further comprising a media player electrically coupled to the three dimensional television.

3) The three dimensional electronic aquarium of claim 1, further comprising a top section placed along a top portion of the three dimensional television.

4) The three dimensional electronic aquarium of claim 3, wherein the top section extends away from the three dimensional television toward the front wall.

5) The three dimensional electronic aquarium of claim 3, wherein the top section is black.

6) The three dimensional electronic aquarium of claim 1, wherein the mirror extends away from the three dimensional television toward the front wall.

7) The three dimensional electronic aquarium of claim 1, wherein the mirror is positioned such that it is angled with respect to a plane perpendicular to the three dimensional television.

8) A three dimensional electronic aquarium, the aquarium comprising:
An aquarium tank cabinet having a base with a plurality of sidewalls rising therefrom, an upper surface is secured to the top of the plurality of sidewalls;
An aquarium tank located on an upper surface of the aquarium tank cabinet comprised of a base having a plurality of sidewalls rising thereform, wherein at least the front wall is transparent;
A three dimensional television secured in a back portion of the aquarium tank opposite the front wall, wherein the three dimensional television will display at least one fish;
A mirror positioned along a bottom portion of the three dimensional television.

9) The three dimensional electronic aquarium of claim 8, further comprising a media player electrically coupled to the three dimensional television.

10) The three dimensional electronic aquarium of claim 8, further comprising a top section placed along a top portion of the three dimensional television.

11) The three dimensional electronic aquarium of claim 10, wherein the top section extends away from the three dimensional television toward the front wall.

12) The three dimensional electronic aquarium of claim 10, wherein the top section is black.

13) The three dimensional electronic aquarium of claim 8, wherein the mirror extends away from the three dimensional television toward the front wall.

14) The three dimensional electronic aquarium of claim 8, wherein the mirror is positioned such that it is angled with respect to a plane perpendicular to the three dimensional television.

15) The three dimensional electronic aquarium of claim 8, wherein the aquarium tank cabinet is further comprised of an opening in a front sidewall;
a door is secured to openably close the opening.

16) The three dimensional electronic aquarium of claim 15, wherein the aquarium tank cabinet has at least one side section rising adjacent to the aquarium tank from the upper surface.

17) The three dimensional electronic aquarium of claim 16, wherein the aquarium tank cabinet has a top section secured to a top of the at least one side section, such that the top section sits along a top of the aquarium tank.

18) A three dimensional electronic aquarium, the aquarium consisting of:
An aquarium tank comprised of a base and at least one sidewall rising thereform;
A three dimensional television secured in a back portion of the aquarium tank, wherein the three dimensional television will display at least one fish;
A mirror positioned along a bottom portion of the three dimensional television.

19) The three dimensional electronic aquarium of claim 18, wherein the mirror extends away from the three dimensional television toward the front wall.

20) The three dimensional electronic aquarium of claim 18, wherein the mirror is positioned such that it is angled with respect to a plane perpendicular to the three dimensional television.
